(19) United States
(12) Patent Application Publication
(10) Pub. No.: US 2018/0141490 A1
(43) Pub. Date: May 24, 2018

(54) INTEGRATED VEHICLE OCCUPANT SAFETY SYSTEM

(71) Applicant: Maricruz Sifuentes, Eagle Pass, TX (US)

(72) Inventor: Maricruz Sifuentes, Eagle Pass, TX (US)

(21) Appl. No.: 15/360,985

(22) Filed: Nov. 23, 2016

(51) Int. Cl. B60Q 1/52; B60W 40/08; B60N 2/00; B60W 10/30

(52) U.S. Cl. CPC B60Q 1/52; B60W 40/08; B60W 2040/0881; B60W 10/30; B60N 2/002

(57) ABSTRACT

An integrated vehicle occupant safety system to alert an emergency responder at regular intervals is disclosed. The integrated vehicle occupant safety system comprises a sensor module placed at one or more predetermined positions inside a vehicle is configured to send a signal to a communication device via a wireless transmitter after a predefined time on detecting the occupant activity inside the vehicle. A smartphone module and an engine control module is configured to activate a vehicle ignition system after another predefined time via the signal transmitted by the sensor module on detecting the occupant activity inside the vehicle. A vehicle tracking system is configured to transmit a location of the vehicle to the emergency responder within the predefined time to rescue the occupant. A method of alerting an emergency responder using an integrated vehicle occupant safety system is disclosed.

### BACKGROUND

Nowadays, parents are not in such a calm environment anymore as the society is filled with busier minds because parents take on more responsibilities than what was taken on before. Especially when it comes to mothers, they need to take on more busier roles. So, all the caretakers are not as common because not everyone look for daycares to take care of their child. So, they must carry their infant or child along with them during the travel in their own vehicle. When someone forgets child in a car, it's more because the mother takes the job of a temporary caretaker even when she is not use to such responsibilities and their mind will be filled with 100 different thoughts, for instance the car speed and so on. However, it's not a good excuse to forget your child but as a single mother of 3 or so, and on the other hand, if you don't get assistance from the father of the child, she will be handicapped and obviously, there are more chances of forgetting the child back in the vehicle. Therefore, each vehicle comes with safety standards and systems to provide safety measures especially for the children. However, all those safety systems aid only during the travel when the caretakers are accompanying the child. But the recent reports say that the number of occupants like children who are left in the vehicle with doors locked and windows rolled up creating an ambience inside the vehicle to risk the occupant's life is alarmingly increasing. The main reason behind this is, the human tendency to forget things easily and nowadays, the stressful life in this fast-paced world causes further to do the same error repeatedly. The inside ambience of the vehicle once it is completely closed, paves the way for sudden death of the occupants in no time as the greenhouse effect to extreme temperatures, causes heat stroke and resulting in death. Through the years, and in most recent years the news reports the loss of a children being left behind unattended in vehicles. Such devestation it brings to a parent when done unintentionally. Most commonly these children are forgotten in extreme hot weather. As our technology has become more advanced one has wondered, how can such an important issue not be attended to. Signs, billboards and news reports are spoken of but no action have actually taken place. Vehicles have such advancements now that the most important feature of a vehicle that should be in consideration due to such high rates that occur in a vehicles of these innocent children is not being emphasized enough. As a single mother of three I understand the busy world and environment we live in, that the Speed that we are pushed to Live on a day to day bases brings us to that forgetfulness that has become a common part of today's society. This issue is not uncommon it has been heard of for the past year and has only increased in the most recent years. With this invention it is brought with such strong emotion and dedication to finally end such horrible occurrences. Keeping the child safe in any given circumstance especially alive. No parent should ever have to live with such horrible regret. The hostile environment projects an atmosphere that brings dangerous scenarios that result in death. Every single soul that has been lost in the contained vehicles with no possibility of liberating themselves should no longer be heard of anymore.

Previous attempts have been made to provide a plurality of alerting systems such as keys in the vehicle to notify the people about the occupants left inside the vehicle. Devices such as portable alarm, wristband, or necklace are provided to alert for this purpose. However, it is convenient and again these devices could be easily forgotten and in a moment of danger, the person may not have those things available, which in turn ‘will not serve the intended purpose when needed. There are some in-built life detecting modules inside the vehicle with oxygen source to help the occupants for some time. However, if the temperature gets worse inside the vehicle, or if the caretaker or any other emergency responder does not respond in time, the occupant may succumbing to the ambience. In some cases, the alerts are limited and if there is no prompt response within expected time frame, there is no use for the intended purpose. In certain prior art, the alerting system does not provide measure of time lapse and randomly sets the alert which is an inefficient process to rescue the occupant. The alerting system may fail due to wear and tear or short circuit, which eventually fails to continue the process for rescuing the unattended occupant.

Prior art reference US 20160049061 discloses a safety sensing system for detection of a mammal in an extreme temperature situation in a vehicle wherein sensors and microcontroller detects the presence of the child inside the vehicle. However, if the alarm system fails to notify any emergency responder, the child in the extreme temperature may succumb to death. Further, it will not provide any favorable environment for staying inside the vehicle for some time until they get a response. Hence, the chance of survival for the child is minimal.

In light of the aforementioned drawbacks and limitations, there exists a need for an integrated safety system in the vehicle to alert any emergency responder using a plurality of alerting methods to save the occupant from the vehicle.

### SUMMARY

The objective of the present invention is to provide an integrated vehicle occupant safety system to alert an emergency responder at regular intervals when an occupant is left back inside the vehicle.

According to one embodiment of the present invention, the integrated vehicle occupant safety system comprises a sensor module placed at one or more predetermined positions inside a vehicle is configured to send a signal to a communication device after a predefined time on detecting the occupant activity inside the vehicle. The sensor module is configured to send a notification to a smartphone module of the emergency responder via at least one of a text message, an email, a voice call and an app alert after the predefined time on detecting the occupant activity inside the vehicle.

According to another embodiment of the present invention, the integrated vehicle occupant safety system comprises an engine control module is configured to activate a vehicle ignition system after another predefined time via the signal transmitted by the sensor module on detecting the occupant activity inside the vehicle. A temperature-controlled module positioned inside the vehicle is configured to adjust the temperature inside the vehicle once the vehicle ignition system is activated on detecting the occupant activity inside the vehicle. A vehicle tracking system is configured to transmit a location of the vehicle to the emergency responder within the predefined time on detecting the occupant activity inside the vehicle, wherein a flashing beacon positioned on a roof of the vehicle is activated to alert the emergency responder to rescue the occupant.

### BRIEF DESCRIPTIONS OF SEVERAL VIEWS OF DRAWINGS

FIG. 1 illustrates an integrated vehicle occupant safety system to alert an emergency responder, according to an embodiment of the present invention.

FIG. 2 illustrates a top view of the integrated vehicle occupant safety system with a sensor module installed therein, according to the embodiment of the present invention.

FIG. 3 illustrates the integrated vehicle occupant safety system to alert an emergency responder with a rear weight sensor installed therein, according to the embodiment of the present invention.

### DETAILED DESCRIPTION OF DIFFERENT EMBODIMENTS

The present invention is related to an integrated vehicle occupant safety system to alert an emergency responder at regular intervals when an occupant is left back inside the vehicle.

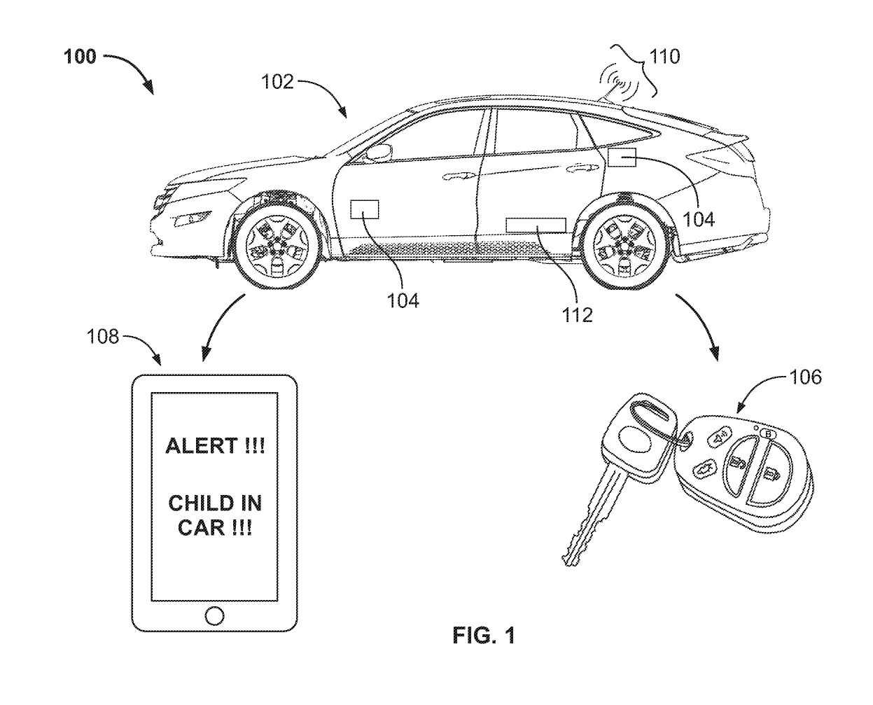

According to an embodiment as shown in FIG. 1, illustrates an integrated vehicle occupant safety system 100 to alert an emergency responder. The integrated vehicle occupant safety system comprises a sensor module 104 placed at one or more predetermined positions inside a vehicle 102 is configured to send a signal to a remote or communication device 106 via a wireless communication after a predefined time on detecting the occupant activity inside the vehicle 102. The sensor module 104 comprises at least one of a motion sensor, a weight sensor and a sound sensor configured to detect the occupant activity and sends the signal to the emergency responder. The signals from sensor module 104 are transmitted via a wireless communication signal to notify the emergency responder about the occupant activity inside the vehicle 102 by detecting the bodily and sound movements inside the vehicle 102. The sensor module 104 is activated after the predefined time of sixty seconds once the occupant is left inside the vehicle 102, and the doors of the vehicle 102 are completely locked. In a preferred embodiment, the communication device 106 is selected from at least one of a remote device and a key fob.

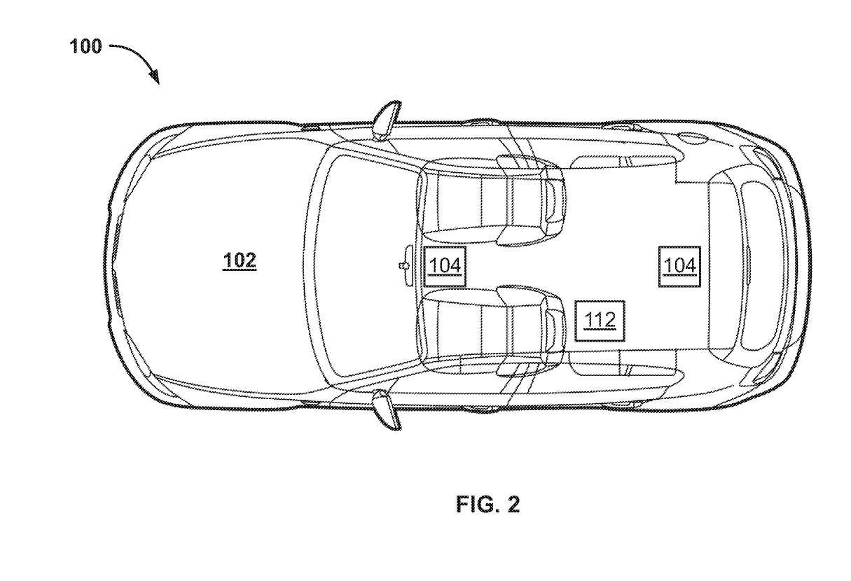

In an embodiment, the remote device 106 is configured to alert the emergency responder via at least one of a sound notification and a light notification within the predefined time of sixty seconds on detecting the occupant activity in the vehicle 102. The sound notification could be a beep sound, and the light notification could be a flashing light or other illumination to alert the emergency responder instantly. The sensor module 104 is configured to be operably positioned at a front section, center section and a rear section of the vehicle 102 as shown in FIG. 2. However, it could be positioned at any other predetermined position inside the vehicle 102 to accomplish the process incorporating the aspects of the present invention. In the present invention, the occupant is at least one of an infant, a child, an elderly person and a physically or mentally disabled person. The emergency responder could be at least one of a user, a driver, a caretaker or any other person who provides care.

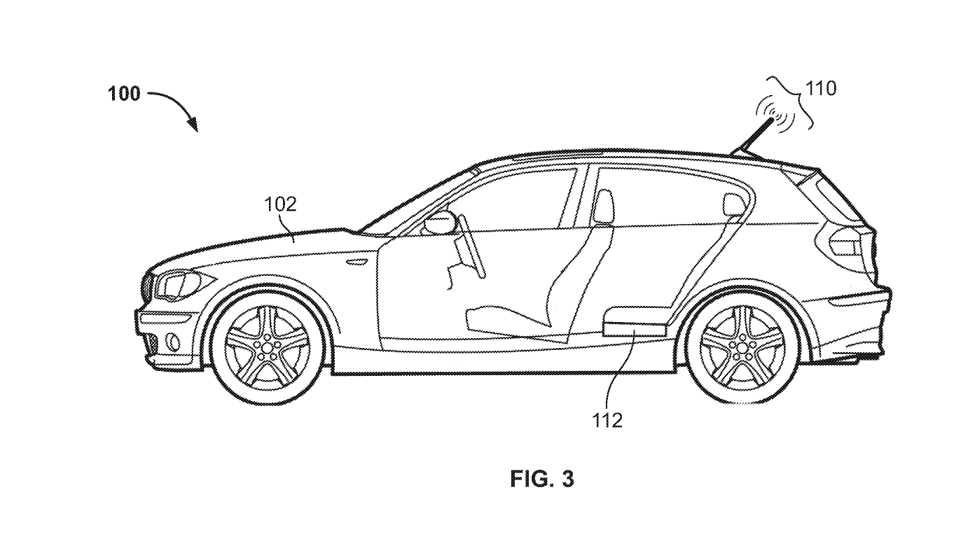

In an embodiment as shown in FIG. 3, the integrated vehicle occupant safety system 100 comprises a weight sensor 112 positioned at the rear seat section of the vehicle 102 to detect the occupant activity inside the vehicle 102 by assessing the weight of the occupant inside the vehicle 102. However, in alternate embodiments, the weight sensor 112 could be positioned in the front seat section of the vehicle 102. As shown in FIG. 1, the sensor module 104 is configured to send a notification to a smartphone module 108 of the emergency responder via at least one of a text message, an email, a voice call and an app alert after the predefined time on detecting the occupant activity inside the vehicle 102. The predefined time could be sixty seconds after the first alert sent to the remote device 106 of the emergency responder. Simultaneously, an engine control module (not shown in figure) is configured to activate a vehicle ignition system via the signal transmitted by the sensor module 104 on detecting the occupant activity inside the vehicle 102. The engine control module simply turns on the vehicle 102 and locks all the doors of the vehicle 102 once the vehicle ignition system is activated on detecting the occupant activity inside the vehicle 102. But the vehicle 102 could not be able to be driven for security purpose.

In a preferred embodiment as shown in FIG. 1, the integrated vehicle occupant safety system 100 further comprises a temperature control module (not shown in figure) is positioned inside the vehicle 102 configured to adjust the temperature inside the vehicle 102 based on the outside weather once the vehicle ignition system is activated on detecting the occupant activity inside the vehicle 102. The temperature control module keeps the temperature inside the vehicle 102 under control and provides a secure and comfortable ambience for the occupants. The temperature control module adjusts the temperature by selectively activating a heater and an air conditioner inside the vehicle 102.

In another embodiment as shown in FIG. 1, if there is no response from the emergency responder like the driver or the vehicle owner, a vehicle tracking system (not shown in figure) is activated and transmit a location of the vehicle 102 to the emergency responder within the predefined time on detecting the occupant activity inside the vehicle 102. A flashing beacon 110 positioned on a roof of the vehicle 102 is activated to alert the emergency responder and rescue the occupant. The flashing beacon 110 is programmed to flash on and off in a unique wig-wag pattern to alert the surrounding area to grab the attention of the emergency responder to save the occupant. Additionally, horn system in the vehicle 102 is configured to produce an audible alert to notify the exact location of the vehicle 102 to the emergency responder to save the occupant. In preferred embodiment, when there is no response from the driver or the vehicle owner, the vehicle tracking system after five minutes, relay the signal to local law enforcement personnel regarding the location of the vehicle 102 and meantime, the horn system and flashing beacon 110 activates to provide the exact location of the vehicle 102 for easier identification by the emergency responder.

In another embodiment as shown in FIG. 1, the integrated vehicle occupant safety system 100 also sends an automatic alert to emergency response centre to get a quick response to save the occupant from the vehicle 102. For example, the automatic alert will be sent to 911 emergency response team for quicker response to rescue the occupant from the vehicle 102. The integrated vehicle occupant safety system 100 further comprises a backup generator to provide additional power to at least one of the engine control module, the temperature control module and the flashing beacon 110 in case the main power source is exhausted. Therefore, if law enforcement personnel fail to reach the vehicle 102 within attempted time frame to rescue the child, the vehicle 102 runs with adjusted temperature and if it runs low on fuel, the backup generator starts adding an alternative energy source to keep engine running for longer time thereby saving the occupant from risking their lives.

In another embodiment as shown in FIG. 1, a method of alerting an emergency responder at regular intervals using an integrated vehicle occupant safety system 100 is disclosed. The method comprises the sequential steps of alerting the emergency responder using all the alerting systems one at a time at regular intervals. The method comprises fixing a sensor module 104 at one or more predetermined positions inside a vehicle 102 wherein the sensor module 104 is configured to send a signal to a communication device 106 via a wireless transmitter after a predefined time on detecting the occupant activity inside the vehicle and sending a notification to a smartphone module 108 of the emergency responder via at least one of a text message, an email, a voice call and an app alert after the predefined time on detecting the occupant activity inside the vehicle 102 by the sensor module 104. It is followed by activating a vehicle ignition system after another predefined time via the signal transmitted by the sensor module 104 on detecting the occupant activity inside the vehicle 102 by an engine control module and adjusting the temperature inside the vehicle 102 once the vehicle ignition system is activated on detecting the occupant activity inside the vehicle via a temperature control module. If there is no response from any of the emergency responder, the integrated vehicle occupant safety system 100 transmits a location of the vehicle 102 to the emergency responder within the predefined time on detecting the occupant activity inside the vehicle 102 via a vehicle tracking system, wherein the flashing beacon 110 positioned on a roof of the vehicle 102 is activated to alert the emergency responder to rescue the occupant.

The integrated vehicle occupant safety system 100, according to the present invention, is configured to provide a plurality of alerting systems such as the sensor module 104, the remote device 106, the smartphone module 108, the temperature control module, the engine control module, the vehicle tracking system, the flashing beacon 110, the horn system, the automatic alert to emergency response centre and the backup generator sequentially from time to time to detect the occupant activity inside the vehicle 102 and get the response from any of the emergency responder. The primary advantage of the integrated vehicle occupant safety system 100 is to provide 100% survival rate for the occupant irrespective of the circumstances inside the vehicle 102. Especially with all back up alarming systems and the automatic adjustment of the temperature inside the vehicle 102 keeps the child safe and alive for longer periods of time until the emergency response is received. The controlled and adjusted air inside the vehicle makes the present invention more effective in rescuing the occupant as the vehicle is kept running to safeguard the occupant. Thus, the chances of death for the occupant is eliminated. The sensor module 104 functions independently within the operating vehicle system and does not experience the wear and tear of consistently using the seat belts as well as placing pressure as using seats on the vehicle 102. The integrated vehicle occupant safety system 100 could rescue the child using one by one alert until the response is received. The flashing beacon 110 helps in easy spotting of the vehicle 102 carrying the occupant by alerting the surrounding environment and emergency responder. The flashing beacon 110 differentiates the vehicle carrying the occupant from other vehicles and in combination with other alarm such as horn, helps the public or emergency responder to get notified easily and rescue the occupant. The backup generator provides alternative source of power to keep the temperature of the vehicle 102 under control for longer time until they get the response from the emergency responder.

Although the present invention has been described herein in the context of a particular implementation in a particular environment for a particular purpose, those of ordinary skill in the art will recognize that its usefulness is not limited thereto and that the present invention may be beneficially implemented in any number of environments for any number of purposes. Accordingly, the claims set forth below should be construed in view of the full breadth and spirit of the present invention as described herein.

1. An integrated vehicle occupant safety system to alert an emergency responder at regular intervals, the system comprises:
a sensor module placed at one or more predetermined positions inside a vehicle is configured to send a signal to a communication device after a predefined time on detecting the occupant activity inside the vehicle;
wherein the sensor module is configured to send a notification to a smartphone module of the emergency responder via at least one of a text message, an email, a voice call and an app alert after the predefined time on detecting the occupant activity inside the vehicle;
an engine control module is configured to activate a vehicle ignition system after another predefined time via the signal transmitted by the sensor module on detecting the occupant activity inside the vehicle;
a temperature control module positioned inside the vehicle is configured to adjust the temperature inside the vehicle once the vehicle ignition system is activated on detecting the occupant activity inside the vehicle;
a vehicle tracking system is configured to transmit a location of the vehicle to the emergency responder within the predefined time on detecting the occupant activity inside the vehicle, wherein a flashing beacon positioned on a roof of the vehicle is activated to alert the emergency responder to rescue the occupant.

2. The system of claim 1, wherein the sensor module comprises at least one of a motion sensor, a weight sensor and a sound sensor configured to send the signal to the communication device when the occupant activity is detected inside the vehicle.

3. The system of claim 1, wherein the sensor module is configured to be operably positioned at a front section, center section and a rear section of the vehicle.

4. The system of claim 1, wherein the weight sensor is operably positioned at the rear seat section of the vehicle.

5. The system of claim 1, wherein the sensor module activates after the predefined time of sixty seconds once the occupant is left inside the vehicle.

6. The system of claim 1, wherein the communication device is selected from at least one of a remote device and a key fob.

7. The system of claim 1, wherein the communication device is configured to alert the emergency responder via at least one of a sound notification and a light notification within the predefined time of sixty seconds.

8. The system of claim 1, wherein the temperature control module is configured to adjust the temperature by selectively activating a heater and an air conditioner inside the vehicle.

9. The system of claim 1, wherein the engine control module is configured to lock all the doors of the vehicle once the vehicle ignition system is activated on detecting the occupant activity inside the vehicle.

10. The system of claim 1, wherein the flashing beacon in the vehicle is programmed to flash on and off in a unique wig-wag pattern to alert the surrounding area to grab the attention of the emergency responder to save the occupant.

11. The system of claim 1, wherein a horn system in the vehicle is configured to produce an audible alert to notify the exact location of the vehicle to the emergency responder to save the occupant.

12. The system of claim 1, sends an automatic alert to emergency response centre to get a quick response to save the occupant from the vehicle.

13. The system of claim 1, comprises a backup generator to provide additional power to at least one of the engine control module, the temperature control module and the flashing beacon in case the main power source is exhausted.

14. A method of alerting an emergency responder at regular intervals using an integrated vehicle occupant safety system, the method comprising:
fixing a sensor module at one or more predetermined positions inside a vehicle wherein the sensor module is configured to send a signal to a communication device via a wireless transmitter after a predefined time on detecting the occupant activity inside the vehicle;
sending a notification to a smartphone module of the emergency responder via at least one of a text message, an email, a voice call and an app alert after the predefined time on detecting the occupant activity inside the vehicle by the sensor module;
activating a vehicle ignition system after another predefined time via the signal transmitted by the sensor module on detecting the occupant activity inside the vehicle by an engine control module;
adjusting the temperature inside the vehicle once the vehicle ignition system is activated on detecting the occupant activity inside the vehicle via a temperature control module;
transmitting a location of the vehicle to the emergency responder within the predefined time on detecting the occupant activity inside the vehicle via a vehicle tracking system, wherein a flashing beacon positioned on a roof of the vehicle is activated to alert the emergency responder to rescue the occupant.
